(19) United States
(12) Patent Application Publication
(10) Pub. No.: US 2007/0103416 A1
(43) Pub. Date: May 10, 2007

(54) LIQUID CRYSTAL DISPLAY AND METHOD FOR DRIVING THE SAME

(76) Inventor: Hyoung-hak KIM, Suwon-si (KR)

Correspondence Address: Frank Chan, Esq.;F. CHAU & ASSOCIATES, LLC, Suite 501, 1900 hempatead Turnpike, East Meadow, NY, 11554, US

(21) Appl. No.: 11/555,770

(22) Filed: Nov. 2, 2006

(30) Foreign Application Priority Data
Nov. 4, 2005 (KR) 10-2005-0105676

(51) Int. Cl. G09G 3/36

(52) U.S. Cl. 345/88

(57) ABSTRACT

An LCD and method for driving the LCD that can prevent hue distortion and variation in color temperature in which the LCD includes a memory storing G (green) gray scale correction values for each gray scale level so that the G gray gamma value for each gray scale measured from the liquid crystal panel without application of the reference gray scale voltage provided from the outside can have the same gamma value as that of the target gamma curve, and a timing controller correcting the G image data among externally input R (red), G, and B (blue) image data according to the G gray scale correction values for each gray scale level stored in the memory and transmitting the corrected G image data and the R and B image data to a data driver at a predetermined timing.

### CROSS REFERENCE TO RELATED APPLICATION

This application claims priority from Korean patent Application No. 10-2005-0105676 filed on Nov. 4, 2005 in the Korean Intellectual Property Office, the disclosure of which is incorporated herein by reference in its entirety.

### BACKGROUND OF THE INVENTION

1. Technical Field

the present disclosure relates to a liquid crystal display (LCD) and a method for driving the LCD and, more particularly, to an LCD and method for driving the same that can prevent hue distortion and variation in color temperature.

2. Discussion of the Related Art

Typically, a liquid crystal display (LCD) is a type of flat panel display for displaying an image using liquid crystals that offers low power consumption, slim lightweight design, and low driving voltage.

An LCD includes a color filter display panel having reference electrodes and color filters, a thin film transistor (TFT) substrate have TFTs and pixel electrodes, and a liquid crystal layer sandwiched between the color filter display panel and the TFT substrate. In the LCD, an electric field is created by applying different electric potentials to a pixel electrode and a reference electrode, and the electric field alters the alignment of liquid crystal molecules to control the transmittance of light. In this way, the LCD displays an image.

The LCD has controlled visibility that allows a color to be sensed differently depending on a gray level when an image is displayed. That is, hue distortion occurs on a screen due to a variation in a gamma value of a gamma curve for each of the R, G, and B colors, Furthermore, although it is ideal to have uniform color temperature regardless of gray level variation in representing a gray level, a color temperature actually significantly increases toward a black level. In an LCD with a patterned vertical alignment (PVA) or super (PVA) (SPVA) mode panel, the brightness level of a red or green component close to zero goes toward black, while that of a blue component is kept high. Thus, an image on the LCD appears very bluish to an observer.

### SUMMARY OF THE INVENTION

Exemplary embodiments of the present invention provide a liquid crystal display (LCD) designed to prevent hue distortion and variation of color temperature when an image is displayed

Exemplary embodiments of the present invention provide a method for driving the LCD that can prevent hue distortion and variation of color temperature when an image is displayed.

According to an embodiment of the present invention, there is provided an LCD including a memory storing G (green) gray scale correction values for each gray scale level so that the G gray gamma value for each gray scale measured from the liquid crystal panel without application of the reference gray scale voltage provided from the outside can have the same gamma value as that of the target gamma curve; and a timing controller correcting the G image data among externally input R (red), G, and B (blue) image data according to the G gray scale correction values for each gray scale level stored in the memory and transmitting the corrected G image data and the R and B image data to a data driver at a predetermined timing.

According to an embodiment of the present invention, there is provided an LCD including a memory storing G (green) gray scale correction values for each gray scale level so that the G gray gamma value for each gray scale measured from the liquid crystal panel without application of the reference gray scale voltage provided from the outside can have the same gamma value as that of the target gamma curve; and a timing controller correcting the G image data among externally input R (red), G, and B (blue) image data according to the G gray scale correction values for each gray scale level stored in the memory, correcting the R and B image data using an ACC (Adaptive Color Correction) and transmitting the corrected, R, G, and B image data to a data driver at a predetermined timing.

According to an embodiment of the present invention, there is provided an LCD including a liquid crystal panel including a plurality of gate lines, a plurality of data lines intersecting the plurality of gate lines, and a plurality of switching elements connected to the plurality of gate lines and the plurality of data lines, a gate driver sequentially applying a gate-on voltage to each of the plurality of gate lines in order to turn on the plurality of switching elements respectively connected thereon, a data driver applying a data voltage representing an image signal to each of the plurality of data lines, and a controller correcting G (green) image data among externally input R (red), G, and B (blue) image data according to G gray scale correction values for each gray scale level so that the G gray gamma value for each gray scale measured from the liquid crystal panel without application of the reference gray scale voltage provided from the outside can have the same gamma value as that of the target gamma curve, transmitting the corrected G image data and the R and B image data to the data driver at a predetermined timing, and generating control signals for controlling the operation of the gate driver and the data driver and outputting the control signals to the gate driver and the data driver.

According to an embodiment of the present invention, there is provided an LCD including a liquid crystal panel including a plurality of gate lines, a plurality of data lines intersecting the plurality of gate lines, and switching elements connected to the plurality of gate lines and the plurality of data lines, a gate driver sequentially applying a gate-on voltage to each of the plurality of gate lines in order to turn on the switching element connected thereto, a data driver applying a data voltage representing an image signal to each of the plurality of data lines, and a controller correcting G (green) image data among externally input R (red), G, and B (blue) image data according to G gray scale correction values for each gray scale level so that the G gray gamma value for each gray scale measured from the liquid crystal panel without application of the reference gray scale voltage provided from the outside can have the same gamma value as that of the target gamma curve, correcting the R and B image data using an ACC (Adaptive Color Correction), transmitting the corrected, R, G, and B image data to the data driver at a predetermined timing, and generating control signals for controlling the operation of the gate driver and the data driver and outputting the control signals to the gate driver and the data driver.

According to an embodiment of the present invention, there is provided a method for driving an LCD including a plurality of gate lines, a plurality of data lines intersecting the plurality of gate lines, a plurality of pixels arranged in a matrix and a plurality of switching elements connected respectively to the plurality of gate lines and the plurality of data lines, the method including: sequentially applying a gate-on voltage for turning on each of the plurality of switching elements respectively connected to a corresponding gate line, correcting G (green) image data among externally input R (red), G, and B (blue) image data according to G gray scale correction values for each gray scale so that the G gray gamma value for each gray scale measured from the liquid crystal panel without application of the reference gray scale voltage provided from the outside can have the same gamma value as that of the target gamma curve and generating data voltages corresponding to the corrected G image data and the R and B image data, and applying the data voltages to a corresponding data line of the plurality of data lines.

According to an embodiment of the present invention, there is provided a method for driving an LCD including a plurality of gate lines, a plurality of data lines intersecting the plurality of gate lines, a plurality of pixels arranged in a matrix and plurality of switching elements connected respectively to the plurality of gate lines and the plurality of data lines, the method including sequentially applying a gate-on voltage for turning on each of the plurality of switching elements respectively connected to a corresponding gate line, correcting G (green) image data among externally input R (red), G, and B (blue) image data according to G gray scale correction values for each gray scale level so that the G gray gamma value for each gray scale measured from the liquid crystal panel without application of the reference gray scale voltage provided from the outside can have the same gamma value as that of the target gamma curve, correcting the R and B image data using ACC (Adaptive Color Correction), and generating data voltages corresponding to the corrected R, G, and B image data, and applying the data voltages to a corresponding data line of the plurality of data lines.

### BRIEF DESCRIPTION OF THE DRAWINGS

Exemplary embodiments of the present invention can be understood in more detail from the following descriptions taken in conjunction with the attached drawings in which:

FIG. 1 is a block diagram of a liquid crystal display (LCD) according to an embodiment of the present invention;

FIG. 2 illustrates a gamma curve for green according to an embodiment of the present invention;

FIG. 3 illustrates a green gray scale correction value for each gray scale according to an embodiment of the present invention;

FIG. 4 illustrates red, green, and blue gray scale correction values for each gray scale obtained using an adaptive color correction (ACC) technique according to an embodiment of the present invention;

FIG. 5 illustrates a gamma curve for green according to an embodiment of the present invention;

FIG. 6 illustrates a gamma curve for green obtained using an ACC technique according to an embodiment of the present invention;

FIG. 7 is a flowchart illustrating the operation of an LCD according to an embodiment of the present invention;

FIG. 8 illustrates the operation of a data driver according to an embodiment of the present invention;

### DETAILED DESCRIPTION OF EXEMPLARY EMBODIMENTS

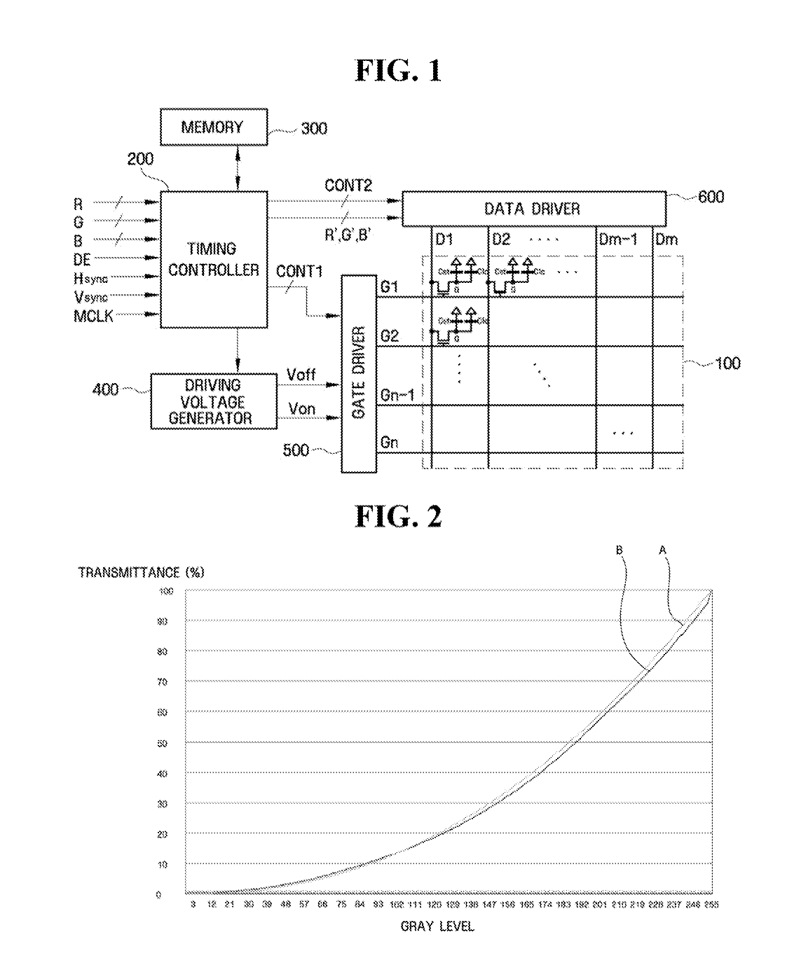

the configuration of a liquid crystal display (LCD) according to an exemplary embodiment of the present invention will now be described in more detail with reference to FIG 1.

FIG. 1 is a block diagram of a liquid crystal display (LCD) according to an embodiment of the present invention.

Referring to FIG. 1, the LCD according to the current embodiment includes a liquid crystal panel 100, a timing controller 200, a memory 300, a driving voltage generator 400, a gate driver 500, and a data driver 600.

As shown in FIG. 1, the liquid crystal panel 100 includes a plurality of pixels arranged in a matrix and connected to a plurality of signal lines including a plurality of gate lines G1 through Gn transmitting gate signals and a plurality of data lines D1 through Dn transmitting data signals.

Each of the plurality of pixels consists of a switching element Q connected to a corresponding one of the plurality of gate lines G1 through Gn and a corresponding one of the plurality of data lines D1 through Dm and a liquid crystal capacitor C_{LC} and a storage capacitor G_{ST} connected to the switching element Q. The storage capacitor C_{ST} may be omitted if necessary.

The switching element Q is formed on a thin film transistor (TFT) substrate. The switching element Q is a three-terminal device consisting of a control terminal connected to the corresponding gate line, an input terminal connected to the corresponding data line, and an output terminal connected to the liquid crystal capacitor C_{LC} and the storage capacitor C_{ST}.

The liquid crystal capacitor C_{LC} has two terminals, that is, a pixel electrode on the TFT substrate and a common electrode on a color filter substrate, and a liquid crystal layer acting as a dielectric material between the pixel electrode and the common electrode. The pixel electrode is connected to the switching element Q and a common electrode, to which a common voltage VCOM is applied, is disposed on the color filter substrate. The common electrode may be provide don the TFT substrate. In this case, both the pixel electrode and the common electrode are linear or bar shaped.

The storage capacitor C_{ST} is formed by overlapping a separate signal line (not shown) on the TFT substrate with the pixel electrode and the common voltage VCOM is applied to the separate signal line, that is, a separate wire type, or by overlapping the pixel electrode with the common electrode, that is, a previous gate type, through an insulating material.

Each pixel can represent color to display a color image. To this end, a red (R), green (G), or blue (B) color filter may be disposed on a region on the color filter substrate corresponding to a pixel electrode or above or below the pixel electrode on the TFT substrate.

A polarizer (not shown) polarizing light is attached to the outside of either or both of the TFT substrate and the color filter substrate.

The timing controller 200 generates a control signal controlling the operation of the gate driver 500 and data driver 600 and provides the same to the gate driver 500 and the data driver 600.

The timing controller 200 corrects G image data among externally provided R, G, and B image data according to a G gray scale correction value for each gray scale stored in the memory 300 and transmits the corrected G image data and the R and B image data to the data driver 600. The timing controller 200 also uses an adaptive color correction (ACC) technique to adjust color coordinates and color temperature of R, G, and B image data. The ACC technique separately adjusts image data for R, G, and B color components in order to prevent visibility caused when each of R, G, B colors is sensed differently for each gray scale and variation in color temperature.

The memory 300 stores G gray scale correction values so that the G gray gamma value for each gray scale measured from the liquid crystal panel without application of the reference gray scale voltage provided from the outside can have the same gamma value as that of the target gamma curve. In this case, the G gray scale correction values for each gray scale is stored in a look up table (LUT). The memory 300 also stores Extended Display Identification Data (EDID) containing monitor information such as vendor, product ID code, and basic display parameters and characteristics and Advanced Dynamic Capacitance Compensation (ADCC) information containing overdrive information. The memory 300 may be an Electrically Erasable Programmable Read Only Memory (EEPROM).

The driving voltage generator 400 produces a plurality of driving voltages, for example, a gate-on voltage Von, a gate-off voltage Voff, and a common voltage VCOM.

The gate driver 500 is connected to the plurality of gate lines G1 through Gn of the liquid crystal panel 100 and applies a gate signal consisting of a combination of the gate-on voltage Von and the gate-off voltage Voff to the gate lines G1 through Gn.

The data driver 600 is coupled to the plurality of data lines D1 through Dm of the liquid crystal panel 100 and typically includes a plurality of integrated circuits (ICs). The data driver 600 selects gray scale voltages corresponding to corrected G image data and R and B image data and applies the gray scale voltages to each pixel as data signals.

The operation of the LCD will now be described in more detail.

The timing controller 200 receives R, G, and B image signals and an input control signal controlling the display of the R, G and B image signals, such as a vertical synchronization signal Vsync and a horizontal synchronization signal Hsync, main clock MCLK and data enable signal DE, from an external graphic controller (not shown). The timing controller 200 also generates a gate control signal CONT1 and a data control signal CONT2 based on the input control signal, processes the R, G, B image signals suitably according to the operation conditions of the liquid crystal panel 100, and provides the gate control signal CONT1 and the data control signal CONT2 and the resulting image signals R′, G′, and B′ to the gate driver 500 and the data driver 600, respectively.

The gate control signal CONT1 includes a vertical synchronization start signal STV for indicating the start of the output of a gate-on pulse (gate-on voltage interval), a gate clock signal CPV for controlling the output time of the gate-on pulse, and an output enable signal OE for defining the width of the gate-on pulse. The output enable signal OE and the gate clock signal CPV are provided to the driving voltage generator 400.

The data control signal CONT2 includes a horizontal synchronization start signal STH for indicating the start of the input of the image data R′, G′, and B′, a load signal LOAD for instructing application of appropriate data voltages to the data lines D1 through Dm, an inversion signal RVS for reversing the polarity of the data voltages with respect to the common voltage VCOM, hereinafter referred to as “the polarity of the data voltages”, and a data clock signal HCLK.

The gate driver 500 sequentially applies a gate-on voltage Von to each of the plurality of gate lines G1 through Gn in response to the gate control signal CONT1 received from the timing controller 200 in order to turn on the switching element Q connected to the gate line.

While the gate-on voltage Von is applied to one of the gate lines G1 through Gn so that one row of switching elements Q connected to the gate line are turned on, representing ‘one horizontal period’ or ‘1H’, the data driver 600 applies each data voltage to a corresponding data line. The 1H is equal to one period of a horizontal synchronization signal Hsync, a data enable signal DE, or a gate clock signal CPV. The data voltage applied to the corresponding data line is then supplied to a corresponding pixel through the turned-on switching element Q.

the data driver 600 sequentially receives image data R′, G′, and B′ corresponding to one row of pixels and converts the image data R′, G′, and B′ into data voltages selected from among the gray scale voltages.

An electric field created by the pixel electrode and the common electrode alters the direction of alignment, thus, changing the polarization of light passing through the liquid crystal layer. The change in polarization results in a change in the amount of transmittance of light transmitted through a polarizer dispose don the TFT substrate and the color filter substrate.

In this way, gate-on voltage Von is sequentially applied to all of the gate lines G1 through Gn during one frame, so that data voltages are applied to all the pixels. When the next frame starts after completing one frame, the inversion signal RVS applied to the data driver 600 is controlled in such a way as to reverse the polarity of data voltages with respect to the polarity of data voltages in the previous frame, which is called “frame inversion”. The inversion signal RVS may be also controlled in such a way as to reverse the polarity of data voltages flowing in a data line in one frame according to characteristics of the inversion signal RVS, which is called “line inversion”, or to reverse the polarity of the data voltages in one row of pixels, which is called “dot inversion”.

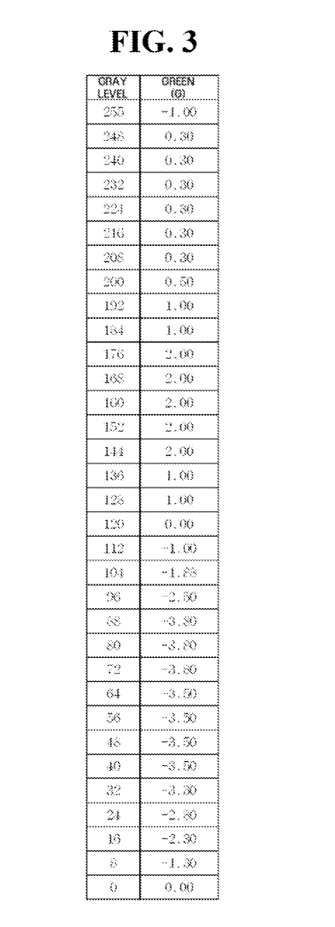

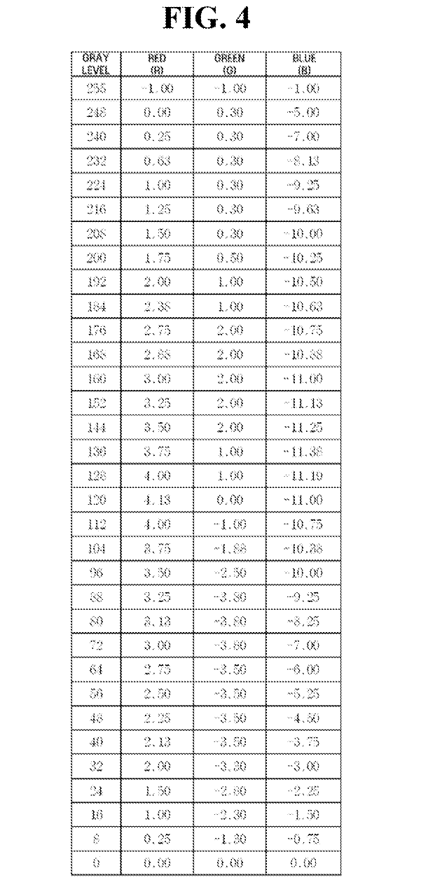

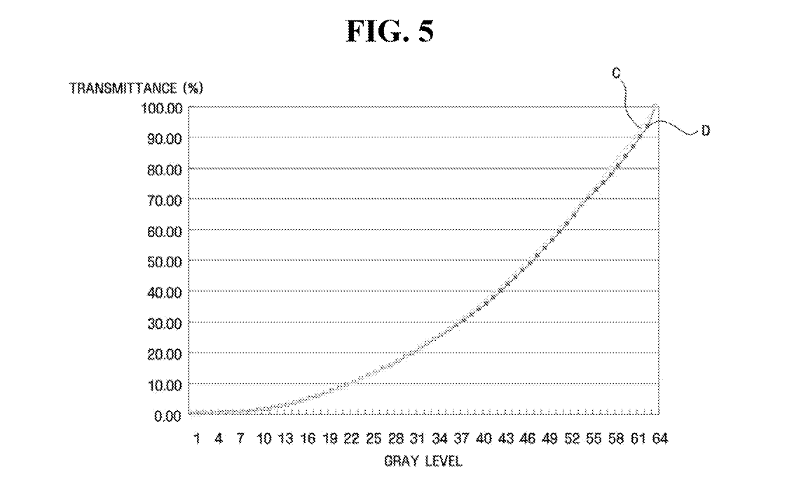

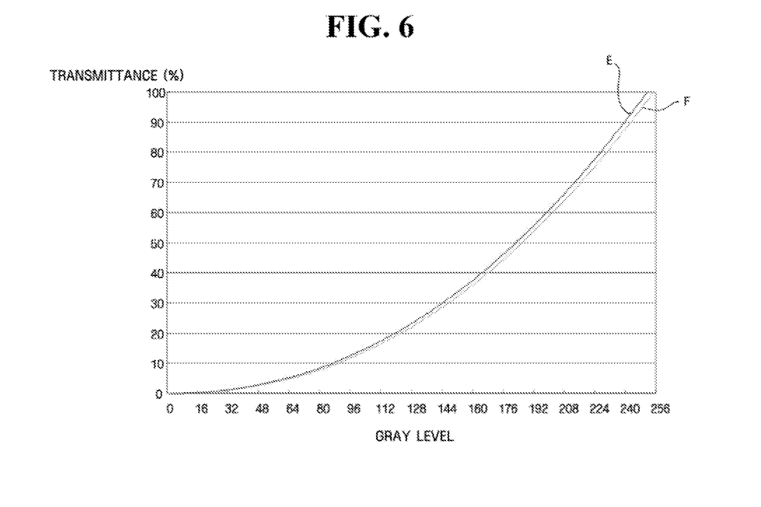

FIG. 2 illustrates a green (G) gamma curve to an embodiment of the present invention and FIG. 3 illustrates a chart of a green gray scale correction value for each gray scale value according to an embodiment of the present invention. FIG. 4 illustrates a chart of red (R), G, and blue (B) gray scale correction values for each gray scale obtained using an ACC technique according to an embodiment of the present invention. FIG. 5 illustrates a G gamma curve according to an embodiment of the present invention and FIG. 6 illustrates a G gamma curve obtained using an ACC technique according to an embodiment of the present invention.

As evident from FIG. 2, a target G gamma curve A has an increased maximum level compared to a conventional G gamma curve B. It is assumed herein that the gamma value of the target G gamma curve A is set to 2.2.

While the gamma value of a target G gamma curve is conventionally realized by adjusting a reference gray scale voltage generated by a gray scale voltage generator (not shown) connected in parallel to an internal resistor (not shown) of the data driver 600, the present invention makes a conventional G gamma curve coincide with a target G gamma curve without application of a reference gray scale voltage generated by a gray scale voltage generator. To achieve this purpose, as illustrated in FIG. 3, the G gray correction values for each gray scale is extracted so that the G gray gamma value for each gray scale measured from the liquid crystal panel without application of the reference gray scale voltage provided from the outside can have the same gamma value as that of the target gamma curve. The extracted G gray scale correction values are stored in the memory 300 using a LUT.

Referring to FIG. 3, G image data with a gray level value reduced by 1.88 is realized in order to actually represent gray level 104. Because no ACC is applied to R and B image data, FIG. 3 does not shown R and B gray scale correction values for each gray scale level.

Furthermore, the present invention eliminates the need to adjust G gray scale correction values for each gray scale level corresponding to the gamma value of the target G gamma curve by controlling a reference gray scale voltage generated by the gray scale voltage generator, thus making it easy to adjust G gray scale correction values for each gray scale level. The absence of the gray scale voltage generator on a printed circuit board (PCB) substrate also reduces the number of components and eliminates the need for a wire connecting the gray scale voltage generator to the data driver, thus reducing the size of the PCB substrate.

Referring to FIG. 4, the LCD of the present invention uses an ACC technique to adjust color coordinates and color temperature of externally input R, G and B image data according to R, G, and B gray scale correction values assigned for each gray scale level. For example, R image data with a gray level value increase by 3.75 and B image data with a gray level value reduced by 10.38 may be realized to represent gray level 104. After producing the R and B gray scale correction values for each gray scale level using ACC, G gray scale correction values for each gray scale level are extracted. Alternatively, the R and B gray scale correction values for each gray scale level can be generated after extracting the G gray scale correction value for each gray scale level. This is possible because only R and B gray scale correction values for each gray scale level may change when the adaptive color correction (ACC) makes a little change in a G gray scale correction value occupying a large percentage of 70 to 80% of the brightness.

As shown in FIGS. 3 and 4, it may be necessary to change G gray scale correction values for each gray scale level according to R and B gray scale correction values both when ACC is applied and when ACC is not applied. That is, the G gray scale correction values for each gray scale level need to be changed only when the gamma value of an actual G gamma curve is made very close to the gamma value of a target G gamma curve. Otherwise, the same G gray scale correction values can be used for each gray scale level regardless of the use of ACC.

FIG. 5 illustrates a G gamma curve for each gray scale level obtained by applying G gray scale correction values for each gray scale level to an actual liquid crystal panel without application of a reference gray scale voltage. As evident from FIG. 5, an actual G gamma curve D almost coincides with a target G gamma curve C. FIG. 6 illustrates a G gamma curve for each gray scale level using ACC without applying a reference gray scale voltage. As evident from FIG. 6, an actual G gamma curve F almost coincides with a target G gamma curve E.

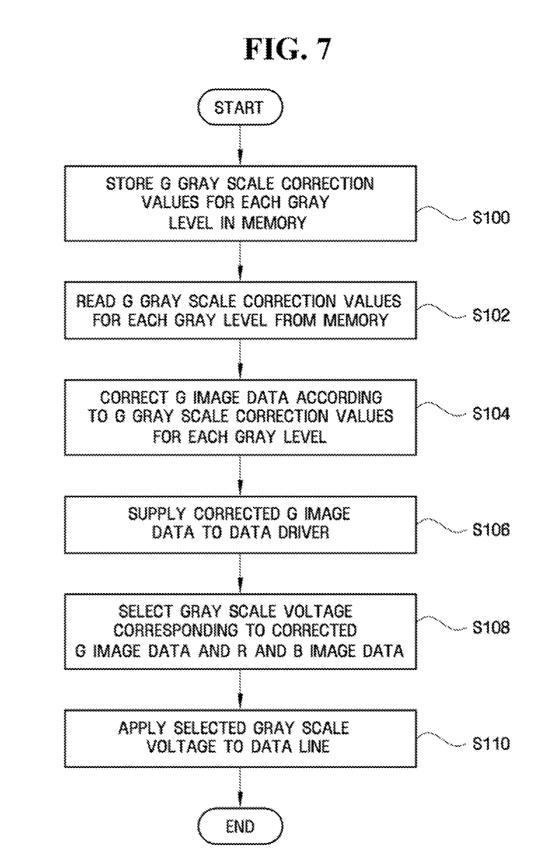

FIG. 7 is a flowchart illustrating the operation of an LCD according to an embodiment of the present invention.

Referring to FIG. 7, in step S100, the G gray correction value is stored in the memory 300 so that the G gray gamma value for each gray scale measured from the liquid crystal panel without application of the reference gray scale voltage provided from the outside can have the same gamma value as that of the target gamma curve. Mere, assuming that the gamma value of the target G gamma curve has been set as 2.2, the G ray correction value for each gray scale is determined.

In step S102, when externally provided R, G, and B image data are input to the timing controller 200, the timing controller 200 reads the G gray scale correction values for each gray scale level from the memory 300.

The timing controller 200 corrects the G image data among the R, G, and B image data according to the G gray scale correction values for each gray scale level in step S104 and provides the corrected G image data to the data driver 600 together with the R and B image data in step S106. In order to adjust color coordinates and color temperature of the R and B image data using the ACC, the timing controller 200 may supply the R and B image data corrected according to the R and B gray scale correction values for each gray scale level, as shown in FIG. 4, to the data driver 600.

the data driver 600 selects gray scale voltages corresponding to the corrected G image data and the R and B image data in step S108 and applies the selected gray scale voltages to each of the data lines in a liquid crystal panel in step S110. When the ACC is applied, the data driver 600 can select gray scale voltages corresponding to the corrected R, G, and B image data and apply the selected gray scale voltages to each of the data lines in the liquid crystal panel.

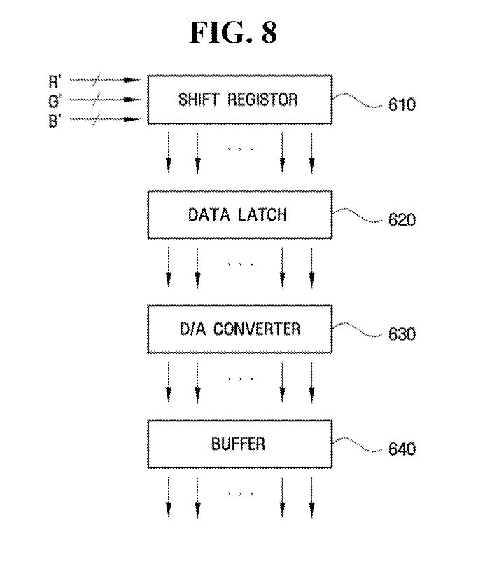

FIG. 8 illustrates the operation of the data driver 600 according to an embodiment of the present invention.

Referring to FIG. 8, the data driver 600 includes a shift register 610, a data latch 620, a digital to analog (D/A) converter 630, and a buffer 640.

The shift register 610 using a predetermined shift clock (not shown), sequentially shifts a control signal received from the timing controller 200 and G image data G′, corrected according to G gray scale correction values for each gray scale level stored in the memory 300, and R and B image data R′ and B′, and stores the image data R′, G′, and ‘B’ in the data latch 620.

The data latch 620 temporarily stores the image data R′, G′, and B′ received from the shift register 610 and provides the stored image data R′, G′, and B′ to the D/A converter 630 in response to the shift clock.

The D/A converter 630 converts the corrected G image data G′ and the image data R′ and B′ provided via the data latch 620 into analog gray scale voltages and provides the analog gray scale voltages to the buffer 640.

The buffer 640 applies the analog gray scale voltages received from the D/A converter 630 to each of the data lines.

While in the above description, the G image data is corrected according to the G gray scale correction values for each gray scale level obtained without using the ACC. The R, G, and B image data can also be corrected according to the R, G, and B gray scale correction values for each gray scale level obtained using the ACC.

An LCD and a method for driving the LCD according to exemplary embodiments of the present invention allow G image data to be corrected according to G gray scale correction values for each gray scale level corresponding to the gamma value of a target gamma curve without application of a reference gray scale voltage before being transmitted to the data driver, thus preventing hue distortion and variation in color temperature.

Exemplary embodiments of the present invention can also allow adjustment of the G gray scale correction values for each gray scale level without a reference gray scale voltage generator, thereby reducing the size of a PCB substrate.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An LCD (Liquid Crystal Display) comprising:
a memory storing G (green) gray scale correction values for each gray scale level so that the G gray gamma value for each gray scale measured from the liquid crystal panel without application of the reference gray scale voltage provided from the outside can have the same gamma value as that of the target gamma curve; and
a timing controller correcting G image data among externally input R (red), G, and B (blue) image data according to the G gray scale correction values for each gray scale level stored in the memory and transmitting the corrected G image data and the R and B image data to a data driver at a predetermined timing.

2. The LCD of claim 1, wherein the memory is separated from the timing controller.

3. The LCD of claim 1, wherein the memory comprises an EEPROM (Electrically Erasable Programmable Read Only Memory).

4. An LCD comprising
a memory storing G (green) gray scale correction values for each gray scale level so that the G gray gamma value for each gray scale measured from the liquid crystal panel without application of the reference gray scale voltage provided from the outside can have the same gamma value as that of the target gamma curve; and
a timing controller correcting G image data among externally input R (red), G, and B (blue) image data according to the G gray scale correction values for each gray scale level stored in the memory, correcting the R and B image data using an ACC (Adaptive Color Correction) and transmitting the corrected R, G, and B image to a data driver at a predetermined timing.

5. The LCD of claim 4, wherein the memory is separated from the timing controller.

6. The LCD of claim 4, wherein the memory comprises an EEPROM (Electrically Erasable Programmable Read Only Memory).

7. An LCD comprising:
a liquid crystal panel including a plurality of gate lines, a plurality of data lines intersecting the plurality of gate lines, and a plurality of switching elements connected to the plurality of gate lines and the plurality of data lines;
a gate driver sequentially applying a gate-on voltage to each of the plurality of gate lines in order to turn on the plurality of switching elements respectively connected thereto;
a data driver applying a data voltage representing an image signal to each of the plurality of data lines; and
a controller correcting G (green) image data among externally input R (red), G, and B (blue) image data according to G gray scale correction values for each gray scale level so that the G gray gamma value for each gray scale measured from the liquid crystal panel without application of the reference gray scale voltage provided from the outside can have the same gamma value as that of the target gamma curve, transmitting the corrected G image data and the R and B image data to the data driver at a predetermined timing, and generating control signals for controlling the operation of the gate driver and the data driver and outputting the control signals to the gate driver and the data driver.

8. The LCD of claim 7, wherein the controller comprises:
a memory storing G (green) gray scale correction values for each gray scale level so that the G gray gamma value for each gray scale measured from the liquid crystal panel without application of the reference gray scale voltage provided from the outside can have the same gamma value as that of the target gamma curve; and
a timing controller correcting G image data among externally input R, G, and B image data according to the G gray scale correction values for each gray scale level stored in the memory and transmitting the corrected G image data and the R and B image data to the data driver at a predetermined timing.

9. The LCD of claim 8, wherein the memory is separated from the timing controller.

10. The LCD of claim 8, wherein the memory comprises an EEPROM (Electrically Erasable Programmable Read Only Memory).

11. The LCD of claim 7, wherein the liquid crystal panel comprises one of a PVA (Patterned Vertical Alignment) and a Super PVA (SPVA) mode panel.

12. An LCD comprising:
a liquid crystal panel including a plurality of gate lines, a plurality of data lines intersecting the plurality of gate lines, and a plurality of switching elements connected to the plurality of gate lines and the plurality of data lines;
a gate driver sequentially applying a gate-on voltage to each of the plurality of gate lines in order to turn on the plurality of switching elements respectively connected thereto;
a data driver applying a data voltage representing an image signal to each of the plurality of data lines; and
a controller correcting G (green) image data among externally input R (red), G, and B (blue) image data according to G gray scale correction values for each gray scale level so that the G gray gamma value for each gray scale measured from the liquid crystal panel without application of the reference gray scale voltage provided from the outside can have the same gamma value as that of the target gamma curve, correcting the R and B image data using an ACC (Adaptive Color Correction), transmitting the corrected R, G, and B image data to the data driver at a predetermined timing, and generating control signals for controlling the operation of the gate driver and the data driver and outputting the control signals to the gate driver and the data driver.

13. The LCD of claim 12, wherein the controller comprises:
a memory storing the G gray scale correction values for each gray scale level so that the G gray gamma value for each gray scale measured from the liquid crystal panel without application of the reference gray scale voltage provided from the outside can have the same gamma value as that of the target gamma curve; and
a timing controller correcting G image data among externally input R, G, and B image data according to the G gray scale correction values for each gray scale level stored in the memory, correcting the R and B image data using an ACC (Adaptive Color Correction) and transmitting the corrected R, G, and B image data to the data driver at a predetermined timing.

14. The LCD of claim 13, wherein the memory is separated from the timing controller.

15. The LCD of claim 13, wherein the memory comprises an EEPROM (Electrically Erasable Programmable Read Only Memory).

16. The LCD of claim 12, wherein the liquid crystal panel comprises one of a PVA (Patterned Vertical Alignment) and a Super PVA (SPVA) mode panel.

17. A method for driving an LCD including a plurality of gate lines, a plurality of data lines intersecting the plurality of gate lines, a plurality of pixels arranged in a matrix and a plurality of switching elements connected respectively to the plurality of gate lines and the plurality of data lines, the method comprising:
sequentially applying a gate-on voltage for turning on each of the plurality of switching elements respectively connected to a corresponding gate line;
correcting G (green) image data among externally input R (red), G, and B (blue) image data according to G gray scale correction values for each gray scale level so that the G gray gamma value for each gray scale measured from the liquid crystal panel without application of the reference gray scale voltage provided from the outside can have the same gamma value as that of the target gamma curve and generating data voltages corresponding to the corrected G image data and the R and B image data; and
applying the data voltages to a corresponding data line of the plurality of data lines.

18. The method of claim 17, wherein the step of generating the data voltages comprises:
setting a gamma value of a target gamma curve, and extracting G gray scale correction values for each gray scale level so that the G gray gamma value for each gray scale measured from the liquid crystal panel without application of the reference gray scale voltage provided from the outside can have the same gamma value as that of the target gamma curve; and
correcting G image data among externally input R, G, and B image data according to the G gray scale correction values for each gray scale level and generating data voltages based on the corrected G image data and the R and B image data.

19. The LCD of claim 17, wherein the liquid crystal panel comprises one of a PVA (Patterned Vertical Alignment) and a Super PVA (SPVA) mode panel.

20. A method for driving an LCD including a plurality of gate lines, a plurality of data lines intersecting the plurality of gate lines, a plurality of pixels arranged in a matrix and plurality of switching elements connected respectively to the plurality of gate lines and the plurality of data lines, the method comprising:
sequentially applying a gate-on voltage for turning on each of the plurality of switching elements respectively connected to a corresponding gate line;
correcting G (green) image data among externally input R (red), G, and B (blue) image data according to G gray scale correction values for each gray scale level so that the G gray gamma value for each gray scale measured from the liquid crystal panel without application of the reference gray scale voltage provided from the outside can have the same gamma value as that of the target gamma curve, correcting the R and B image data using an ACC (Adaptive Color Correction), and generating data voltages corresponding to the corrected R, G, and B image data; and
applying the data voltages to a corresponding data line of the plurality of data lines.

21. The method of claim 20, wherein the step of generating the data voltages comprises:
setting a gamma value of a target gamma curve, and extracting G gray scale correction values for each gray scale level so that the G gray gamma value for each gray scale measured from the liquid crystal panel without application of the reference gray scale voltage provided from the outside can have the same gamma value as that of the target gamma curve; and
correcting G image data among externally input R, G, and B image data according to the G gray scale correction values for each gray scale level and correcting the R and B image data using an ACC (Adaptive Color Correction) and generating data voltages based on the corrected G image data and the R and B image data.

22. The method of claim 20, wherein the liquid crystal panel comprises one of a PVA (Patterned Vertical Alignment) and a Super PVA (SPVA) mode panel.
